(19) United States
(12) Patent Application Publication
(10) Pub. No.: US 2024/0086677 A1
(43) Pub. Date: Mar. 14, 2024

(54) LEARNED COLUMN-WEIGHTS FOR RAPID-ESTIMATION OF PROPERTIES OF AN ENTIRE EXCITATION VECTOR

(71) Applicant: INTERNATIONAL BUSINESS MACHINES CORPORATION, ARMONK, NY (US)

(72) Inventors: Geoffrey Burr, Cupertino, CA (US); Malte Johannes Rasch, Chappaqua, NY (US)

(21) Appl. No.: 17/931,538

(22) Filed: Sep. 12, 2022

(51) Int. Cl. G06N 3/02; G06N 5/04

(52) U.S. Cl. CPC G06N 3/02; G06N 5/04

(57) ABSTRACT

A method includes receiving, at a neural network weight layer of an artificial neural network, an incoming excitation vector. The artificial neural network includes one or more operations requiring one or more scalar values, such as a mean or a standard deviation, to be computed across an output data vector of the artificial neural network. The method further includes using a predicted representation of the one or more scalar values during forward inference of the artificial neural network by the incoming excitation vector to apply the one or more operations to the output data vector, thus avoiding any computation needed to compute an exact representation of the one or more scalar values from the output data vector.

### BACKGROUND

### Technical Field

The present disclosure generally relates to neural-network hardware, and more particularly, to a method for adding additional columns (or rows) to an Analog-AI tile in order to encode learned weights that have been trained to produce salient data-dependent coefficients, such as the mean or standard deviation of the tile output-vector.

### Description of the Related Art

Rapid improvements in AI hardware accelerators have been a hidden but pivotal driver of progress in Deep Neural Networks (DNNs). Better hardware enabled the training of very large networks with enormous datasets, as well as rapid inference of the resulting large and thus highly-capable DNN models. Current DNN hardware ranges from modern GPUs (Graphics Processing Units) with numerous features designed specifically for DNN training and inference, to specialized digital CMOS accelerators incorporating reduced precision, sparsity, dataflow architectures, hardware-software optimization, and very-large-area accelerator chips. In general, such accelerators must carefully orchestrate the flow of vast amounts of data between on-chip or off-chip volatile memories (SRAM and DRAM) and highly-specialized SIMD (Single Instruction Multiple Data) units. These units perform the multiply-accumulate instructions that dominate most DNN compute workloads. This data-flow not only encompasses the many neuron activations produced by each DNN layer, but also the DNN model-weights and partial-sums as well.

Recently, Compute-In-Memory (CIM) designs that can improve energy-efficiency (e.g., by performing the multiply-accumulate operations with time complexity within on-chip memory) do so by reducing the motion of DNN model-weights and partial-sums. By exploiting such weight-stationarity over a short timespan with volatile memories such as SRAM or DRAM or over longer timespans with slower and finite-endurance non-volatile memories (NVM) such as Flash, Resistive RAM (RRAM), Magnetic Random-Access Memory (MRAM), or Phase-Change Memory (PCM), CIM approaches can offer both high-speed and high energy-efficiency. These benefits can be seen across all DNN workloads, but are particularly pronounced for workloads that exhibit large fully-connected layers with low weight reuse. However, since most of these memories offer only binary or few-bit storage, spatial-multiplexing across multiple word- or bit-lines must be invoked to implement the multi-bit weights needed for state-of-the-art DNN performance. This trades off area and energy to achieve the necessary multiply-accumulate precision, typically paired with time-multiplexing on the word- or bit-lines to support multi-bit activations.

Some emerging non-volatile memories, such as PCM and RRAM, exhibit a broad and continuous range of analog conductance states, offering a path towards high-density weight-storage. Such devices also introduce additional considerations, such as weight-programming errors, readout noise, and conductance drift. This Analog-AI paradigm, in which energy-efficient multiply-accumulate (MAC) operations are performed on area-efficient crossbar-array tiles of analog non-volatile memory, represents a particularly attractive form of Compute-In-Memory for hardware acceleration of DNN workloads. In this paradigm, vector-matrix-multiply operations are performed with excitation vectors introduced onto multiple row-lines, in order to implement multiply and accumulate (MAC) operations across an entire matrix of stored weights encoded into the conductance values of analog nonvolatile resistive memories.

Ideally, output vectors produced by such operations could then be processed with nearby digital processing in a completely-vectorized manner, e.g., affine scaling, ReLU, sigmoid or other operations that can be performed with highly-parallelized Single-Instruction-Multiple-Data (SIMD)-type operations that can operate on each member of the vector in parallel with minimal need to wait before computation.

However, there are some network layers that require scaling by a data-dependent coefficient, such as the maximum of the output vector, the average, or the standard deviation. The need for such compute suggests that highly-parallelized SIMD compute is forced to wait for the computation of these scaling coefficients before the efficient localized compute (e.g., application of this multiplicative scaling coefficient) can take place. This is particularly troublesome when it is necessary to divide by the maximum, because the maximum is computed by looking at all members of the vector, then its inverse is computed, and only after this computation can efficient SIMD multiplication be performed on each vector element.

Presently, there are no methods to obtain these data-dependent coefficients in a manner that makes them available as soon as the data-vector itself is digitized.

### SUMMARY

According to various embodiments, a computing device, a non-transitory computer readable storage medium, and a method are provided for adding additional columns (or rows) to an Analog-AI tile to encoded learned weights that are trained to produce the salient data-dependent coefficients, such as maximum, average, or standard-deviation in order to provide lower latency, faster compute performance, and reduced digital-compute energy in exchange for a very modest increase in Analog-AI tile energy, as well as some potential impact on neural network accuracy due to any discrepancy between the predictions of these salient data-dependent coefficients and their exact computed values.

In one embodiment, a method includes receiving, at a neural network weight layer of an artificial neural network, an incoming excitation vector. The artificial neural network includes one or more operations involving one or more scalar values, such as a mean or a standard deviation, to be computed across an output data vector of the artificial neural network. The method further includes using a predicted representation of the one or more scalar values during forward inference of the artificial neural network by the incoming excitation vector to apply the one or more operations to the output data vector, thus avoiding any computation needed to compute an exact representation of the one or more scalar values from the output data vector.

In one embodiment, the one or more operations includes one or more of a mean or a standard deviation, and the one or more operations involve access to every element of the output data vector.

In one embodiment, the method further includes providing training input from a set of training data to an artificial neural network, the training input providing the trained weights for the neural network weight layer.

In one embodiment, the method further includes providing additional training weights for predicting the one or more scalar values from the incoming excitation vector used to compute the output data vector. The method can further include producing the predicted representation simultaneously with a computation of the output data vector based on the additional training weights.

In one embodiment, the additional training weights are provided on one or more columns of an analog artificial intelligence tile including the neural network weight layer.

In one embodiment, the method further comprises training the additional training weights, together with the artificial neural network, by minimizing a loss between the predicted representation and a calculated representation of the one or more scalar values.

In one embodiment, a computer implemented method for applying one or more operations to an output data vector of an analog artificial intelligence tile includes receiving, at a neural network weight layer of the analog artificial intelligence tile, an incoming excitation vector. The method further includes computing an output data vector based on trained weights in the neural network weight layer and storing, in one or more rows or columns of the artificial intelligence tile, additional trained weights for providing a predicted representation of one or more scalar values to be applied to the output data vector. The method further includes using the predicted representation of the one or more scalar values during forward inference of the artificial neural network by the incoming excitation vector to apply the one or more operations to the output data vector while avoiding any computation needed to compute an exact representation of the one or more scalar values from the output data vector.

By virtue of the concepts discussed herein, a system and method are provided that improves upon the approaches currently used to perform parallel vector-multiply operations with excitation vectors introduced onto multiple row-lines in order to perform multiply and accumulate (MAC) operations across an entire matrix of stored weights encoded into the conductance values of analog nonvolatile resistive memories.

The system and methods discussed herein have the technical effect of providing lower latency, faster compute performance, and reduced digital-compute energy.

These and other features will become apparent from the following detailed description of illustrative embodiments thereof, which is to be read in connection with the accompanying drawings.

### BRIEF DESCRIPTION OF THE DRAWINGS

The drawings are of illustrative embodiments. They do not illustrate all embodiments. Other embodiments may be used in addition or instead. Details that may be apparent or unnecessary may be omitted to save space or for more effective illustration. Some embodiments may be practiced with additional components or steps and/or without all the components or steps that are illustrated. When the same numeral appears in different drawings, it refers to the same or like components or steps.

FIG. 1 is a representation of a standard model for performing parallel vector-multiply operations with excitation vectors introduced onto multiple row-lines in order to perform multiply and accumulate (MAC) operations across an entire matrix of stored weights encoded into the conductance values of an analog nonvolatile resistive memory, according to conventional practices. It is understood to those skilled in the art that a tile which introduced excitation vectors onto multiple column-lines and performed MAC operations by integrating along rows (rather than along columns) would be an obvious extension of the present disclosure.

FIG. 2 is a representation of a model for performing parallel vector-multiply operations with excitation vectors introduced onto multiple row-lines in order to perform multiply and accumulate (MAC) operations across an entire matrix of stored weights encoded into the conductance values of an analog nonvolatile resistive memory according to an illustrative embodiment.

FIG. 3 is a flow chart illustrating multilayer perceptron testing on an image dataset, showing a comparison between the standard model of FIG. 1 and the model according to the illustrative embodiment of FIG. 2.

FIG. 4 is a representation of the standard model of FIG. 1 used in the testing procedure of FIG. 3.

FIG. 5 is a representation of the model according to the illustrative example of FIG. 2 used in the testing procedure of FIG. 3.

FIG. 6 is a graph showing the results of the testing illustrated in FIG. 3.

FIG. 7 is a flow chart exemplifying a method for performing parallel vector-multiply operations with excitation vectors introduced onto multiple row-lines in order to perform multiply and accumulate (MAC) operations across an entire matrix of stored weights encoded into the conductance values of an analog nonvolatile resistive memory, according to an illustrative embodiment.

FIG. 8 is a functional block diagram illustration of a computer hardware platform that can be used to implement the illustrative embodiment of FIG. 2.

### DETAILED DESCRIPTION

### Overview

In the following detailed description, numerous specific details are set forth by way of examples to provide a thorough understanding of the relevant teachings. However, it should be apparent that the present teachings may be practiced without such details. In other instances, well-known methods, procedures, components, and/or circuitry have been described at a relatively high-level, without detail, to avoid unnecessarily obscuring aspects of the present teachings.

Unless specifically stated otherwise, and as may be apparent from the following description and claims, it should be appreciated that throughout the specification descriptions utilizing terms such as “processing,” “computing,” “calculating,” “determining,” or the like, refer to the action and/or processes of a computer or computing system, or similar electronic computing device, that manipulate and/or transform data represented as physical, such as electronic, quantities within the computing system's registers and/or memories into other data similarly represented as physical quantities within the computing system's memories, registers or other such information storage, transmission or display devices.

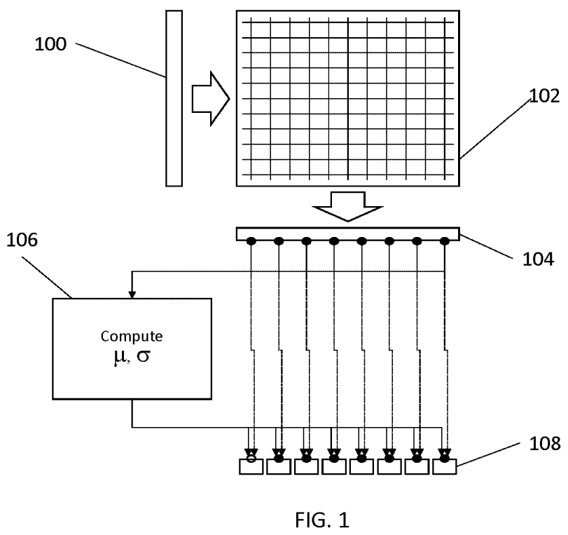

Referring to FIG. 1, a conventional architecture is illustrated for performing parallel vector-multiply operations with an excitation vector 100 introduced onto multiple row-lines of a fully-connected weight layer 102 in order to perform multiply and accumulate (MAC) operations across an entire matrix of stored weights encoded into the conductance values of analog nonvolatile resistive memories. While this representative example shows a fully connected weight layer, other neural network layers such as convolutional layers could potentially be addressed by the disclosure, in scenarios where a mean, standard-deviation or other similar operation will need to be performed across the output vector produced by the tile. An output vector 104 produced by such operations could then be processed with nearby digital processing in a completely-vectorized manner with highly-parallelized SIMD-type operations that can operate on each member of the output vector 104 in parallel with minimal need to wait before computation.

However, there are some network layers that involve scaling by a data-dependent coefficient, such as the maximum of the output vector, the average (μ), or the standard deviation (σ). Such computations are expected to take place, as illustrated in block 106, while the vector data and parallel compute sit idle. Only after these values are calculated can the scaled output vector 108 be provided.

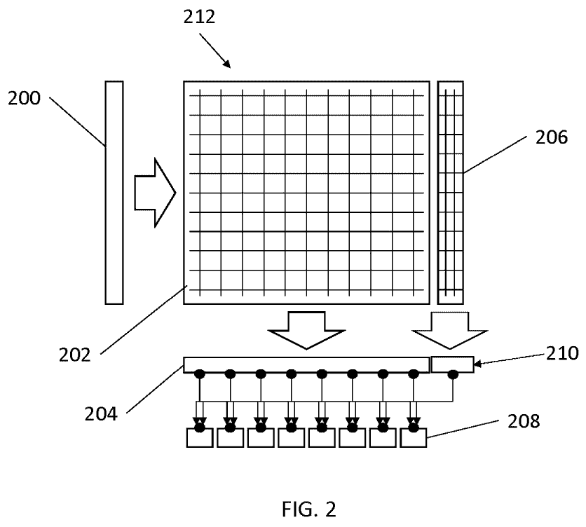

Referring now to FIG. 2, according to the present disclosure, an architecture is illustrated for performing parallel vector-multiply operations with an excitation vector 200 introduced onto multiple row-lines of a fully connected weight layer 202 in order to perform MAC operations across an entire matrix of stored weights encoded into the conductance values of analog nonvolatile resistive memories.

An output vector 204 produced by such operations that involve scaling by a data-dependent coefficient, such as the maximum of the output vector, the average (μ), or the standard deviation (σ) can be applied to the output vector 204 immediately to produce the scaled output vector 208, without the need to sit idle to wait for a separate computation of these data-dependent coefficients.

Additional columns 206 (or rows) of an Analog-AI tile 212 can be used to encoded learned weights that are trained to predict the salient data-dependent coefficients 210, such as maximum, average, or standard-deviation, from the same input vector 200 as it is being used to produce the output vector 204. The advantage of this approach is lower latency, faster compute performance, and reduced digital-compute energy, as the data-dependent coefficients 210 are available for immediate vectorized SIMD-type compute for each member of the data vector, without the need to delay and compute this value from the vector itself.

Since these additional columns 206 are activated with exactly the same upstream row excitations as the remainder of the weight-matrix, the training operation should be able to converge and produce weights which accurately estimate the resulting maximum, average or standard-deviation from this given input excitation vector 200. This involves adaptation of the learning process so that these weights are optimized based on their accuracy in predicting the maximum, average, standard-deviation, or other local computation based on the raw excitation vector produced by the associated weight-matrix.

Weights in the fully connected weight layer 202 are trained so as to minimize U=y_{network_guess}−y_{label}. Other terms can be added to the Energy Function U, as shown in the formula, U=λ*(y_{network_guess}−y_{label})+(1−λ)*Q, where Q is a quantity that is desirable to be minimized. Accordingly, the present disclosure describes the inclusion of additional columns 206 of weights, where the regularization-term (added component in U) attempts to minimize the difference between the data-dependent coefficients 210 and the calculated data-dependent coefficient values, such as the calculated mean and standard deviation calculated in block 106 of FIG. 1.

As a result, the operation of the Analog-AI tile produces an accurate estimate of the maximum, average, or standard-deviation, which is available for immediate vectorized SIMD-type compute for each member of the data vector, without the need to delay and compute this value from the vector itself.

### EXAMPLE

The layernorm operation, as illustrated in the below equations, is expensive in terms of resource area, resource power, and total latency. Such an operation involves at least two loops (in parallel), one to sum X to calculate the mean and another to sum X² to calculate the standard deviation.

$$\\ {\hat{x}}_{k} = \frac{{x}_{k} - μ}{\sqrt{{σ}^{2} + ϵ}}$$

$$\\ μ = \frac{1}{N} {\sum }_{k = 1}^{N} {x}_{k}$$

$$\\ {σ}^{2} = \frac{1}{N} {\sum }_{k = 1}^{N} {( {x}_{k} - μ )}^{2} = \frac{1}{N} ( {\sum }_{k = 1}^{N} {x}_{k}^{2} ) - {μ}^{2}$$

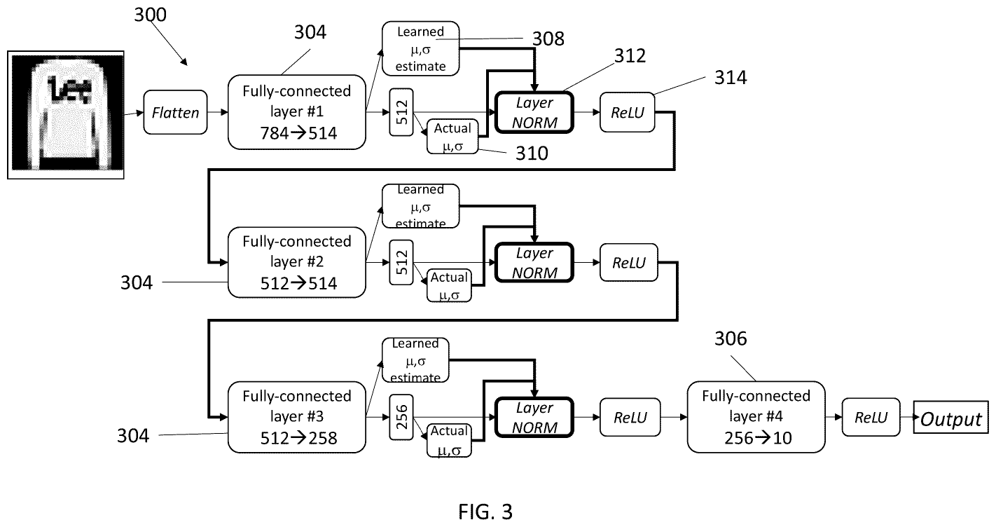

Referring to FIG. 3, a flow chart 300 illustrates multilayer perceptron (MLP) testing on an image dataset having a plurality of images 302. For this example, a network with three fully connected layers 304 having layer normalization 312 performed, and a fourth layer 306 without layer normalization. As illustrated, the flow chart 300 can proceed with actual mean and standard deviation values 310, as conventionally practiced and as illustrated in FIG. 1, or the flow chart 300 can proceed using the learned mean and standard deviations, as illustrated in FIG. 2, according to aspects of the present disclosure. A ReLU operation 314 is performed on the layernorm operation 312 output (or, in the fourth layer 306, directly on the output of the fourth layer 306) to provide the tile output.

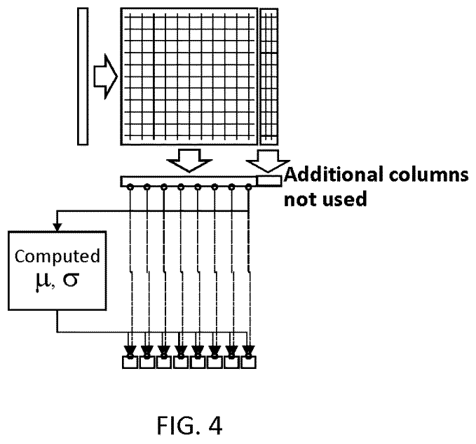

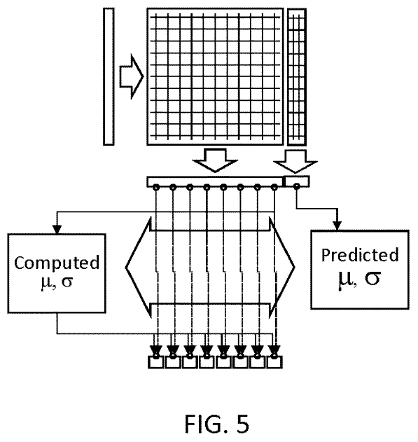

As shown in FIGS. 4 and 5, the example illustrated in the flow chart 300 of FIG. 3 was trained in two steps. First, normal training was performed, where the model was trained in a conventional manner on the dataset in 10 epochs. Second, the extra columns were trained using the calculated statistics as targets in 10 epochs.

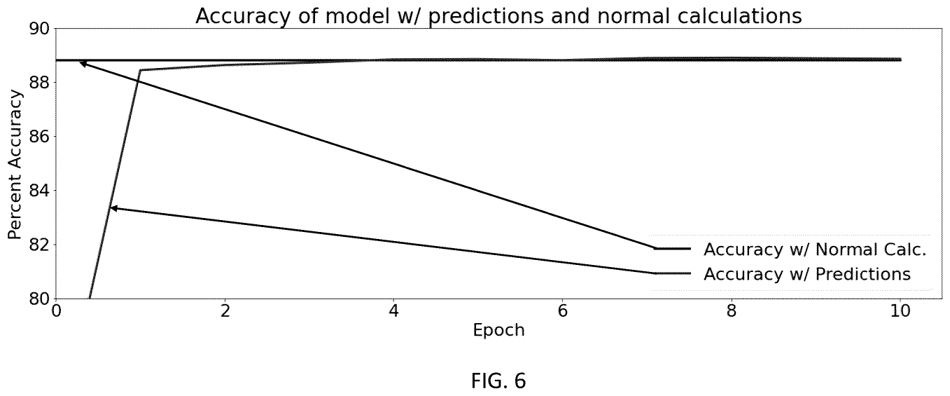

As shown in FIG. 6, the accuracy of the model with the extra columns, according to aspects of the present disclosure, approaches that of the conventional calculated data-dependent coefficients (such as mean and standard deviation) after the third training epoch.

### Example Process

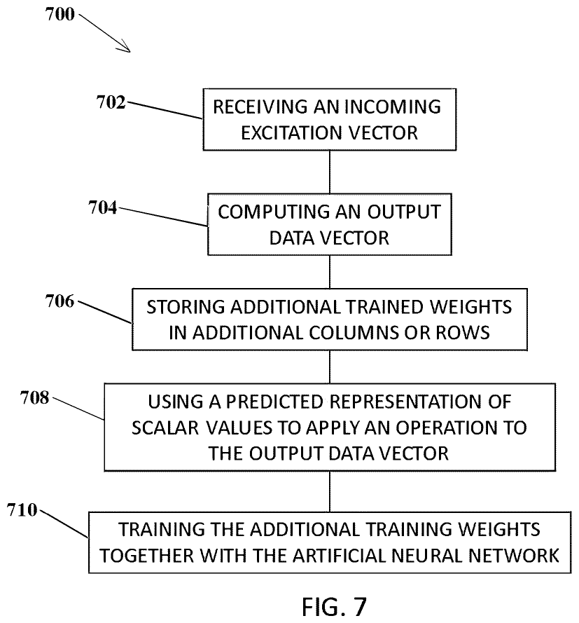

It may be helpful now to consider a high-level discussion of an example process. To that end, FIG. 7 presents an illustrative process 700 related to the methods for adding additional columns (or rows) to an Analog-AI tile to encoded learned weights that are trained to produce the salient data-dependent coefficients, such as maximum, average or standard-deviation. Process 700 is illustrated as a collection of blocks, in a logical flowchart, which represents a sequence of operations that can be implemented in hardware, software, or a combination thereof. In the context of software, the blocks represent computer-executable instructions that, when executed by one or more processors, perform the recited operations. Generally, computer-executable instructions may include routines, programs, objects, components, data structures, and the like that perform functions or implement abstract data types. In each process, the order in which the operations are described is not intended to be construed as a limitation, and any number of the described blocks can be combined in any order and/or performed in parallel to implement the process.

Referring to FIG. 7, the process 700 can include an act 702 of receiving, at a fully connected weight layer of the analog artificial intelligence tile, an incoming excitation vector. The process 700 can further include an act 704 of computing an output data vector based on trained weights in the fully connected weight layer. The process 700 can further include an act 706 of storing, in one or more rows or columns of the artificial intelligence tile, additional trained weights for providing a predicted representation of one or more scalar values to be applied to the output data vector. The process 700 can further include an act 708 of using the predicted representation of the one or more scalar values during forward inference of the artificial neural network by the incoming excitation vector to apply the one or more operations to the output data vector while avoiding any computation needed to compute an exact representation of the one or more scalar values from the output data vector. The process 700 can further include an act 710 of training the additional training weights, together with the artificial neural network, by minimizing a loss between the predicted representation and a calculated representation of the one or more scalar values.

### Example Computing Platform

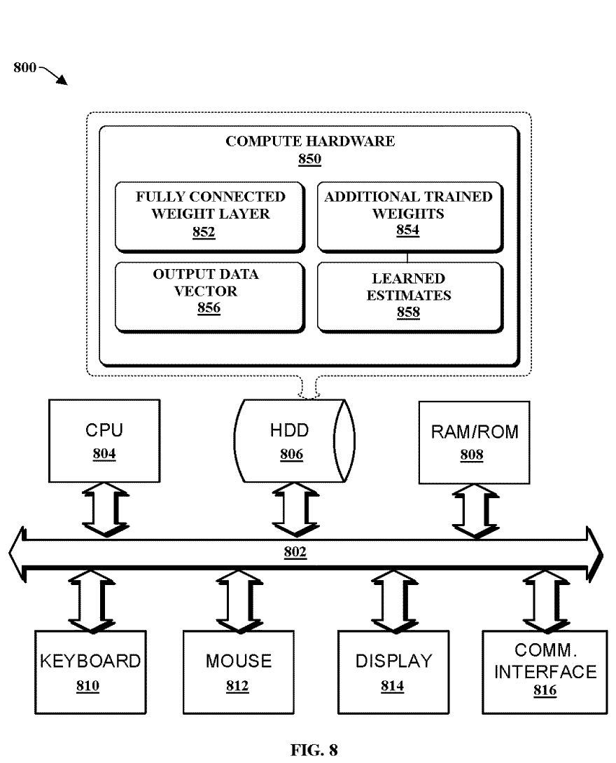

FIG. 8 provides a functional block diagram illustration of a computer hardware platform 800 that can be used to implement a particularly configured computing device that can host compute hardware 850 for applying one or more operations to an output data vector of an analog artificial intelligence tile. The compute hardware 850 can include a fully connected weight layer 852, such as the fully connected weight layer 202 discussed above, an additional set of additional trained weights 854, such as the additional trained weights 206 discussed above, an output data vector 856, such as the output data vector 210 discussed above, and learned estimates 858, such as the learned estimates 210 discussed above, computed from the additional trained weights 854.

The computer platform 800 may include a central processing unit (CPU) 810, a hard disk drive (HDD) 820, random access memory (RAM) and/or read only memory (ROM) 830, a keyboard 850, a mouse 860, a display 870, and a communication interface 880, which are connected to a system bus 840. In one embodiment, the compute hardware 850 has capabilities that include performing the methods, as discussed above.

### CONCLUSION

The descriptions of the various embodiments of the present teachings have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

While the foregoing has described what are considered to be the best state and/or other examples, it is understood that various modifications may be made therein and that the subject matter disclosed herein may be implemented in various forms and examples, and that the teachings may be applied in numerous applications, only some of which have been described herein. It is intended by the following claims to claim any and all applications, modifications, and variations that fall within the true scope of the present teachings.

The components, steps, features, objects, benefits, and advantages that have been discussed herein are merely illustrative. None of them, nor the discussions relating to them, are intended to limit the scope of protection. While various advantages have been discussed herein, it will be understood that not all embodiments necessarily include all advantages. Unless otherwise stated, all measurements, values, ratings, positions, magnitudes, sizes, and other specifications that are set forth in this specification, including in the claims that follow, are approximate, not exact. They are intended to have a reasonable range that is consistent with the functions to which they relate and with what is customary in the art to which they pertain.

Numerous other embodiments are also contemplated. These include embodiments that have fewer, additional, and/or different components, steps, features, objects, benefits and advantages. These also include embodiments in which the components and/or steps are arranged and/or ordered differently.

Aspects of the present disclosure are described herein with reference to a flowchart illustration and/or block diagram of a method, apparatus (systems), and computer program products according to embodiments of the present disclosure. It will be understood that each block of the flowchart illustrations and/or block diagrams, and combinations of blocks in the flowchart illustrations and/or block diagrams, can be implemented by computer readable program instructions.

These computer readable program instructions may be provided to a processor of an appropriately configured computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The call-flow, flowchart, and block diagrams in the figures herein illustrate the architecture, functionality, and operation of possible implementations of systems, methods, and computer program products according to various embodiments of the present disclosure. In this regard, each block in the flowchart or block diagrams may represent a module, segment, or portion of instructions, which comprises one or more executable instructions for implementing the specified logical function(s). In some alternative implementations, the functions noted in the blocks may occur out of order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

While the foregoing has been described in conjunction with exemplary embodiments, it is understood that the term “exemplary” is merely meant as an example, rather than the best or optimal. Except as stated immediately above, nothing that has been stated or illustrated is intended or should be interpreted to cause a dedication of any component, step, feature, object, benefit, advantage, or equivalent to the public, regardless of whether it is or is not recited in the claims.

It will be understood that the terms and expressions used herein have the ordinary meaning as is accorded to such terms and expressions with respect to their corresponding respective areas of inquiry and study except where specific meanings have otherwise been set forth herein. Relational terms such as first and second and the like may be used solely to distinguish one entity or action from another without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “a” or “an” does not, without further constraints, preclude the existence of additional identical elements in the process, method, article, or apparatus that comprises the element.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments have more features than are expressly recited in each claim. Rather, as the following claims reflect, the inventive subject matter lies in less than all features of a single disclosed embodiment. Thus, the following claims are hereby incorporated into the Detailed Description, with each claim standing on its own as a separately claimed subject matter.

What is claimed is:

1. A method comprising:
receiving, at a neural network weight layer of an artificial neural network, an incoming excitation vector, the artificial neural network including one or more operations involving one or more scalar values to be computed across an output data vector of the artificial neural network;
using a predicted representation of the one or more scalar values during forward inference of the artificial neural network by the incoming excitation vector to apply the one or more operations to the output data vector.

2. The method of claim 1, wherein a computation used to compute an exact representation of the one or more scalar values from the output data vector is avoided.

3. The method of claim 1, wherein the one or more operations includes a mean and/or a standard deviation.

4. The method of claim 1, wherein the one or more operations involve access to every element of the output data vector.

5. The method of claim 1, further comprising providing training input from a set of training data to an artificial neural network, the training input providing the trained weights for the neural network weight layer.

6. The method of claim 5, further comprising:
providing additional training weights for predicting the one or more scalar values from the incoming excitation vector used to compute the output data vector; and
producing the predicted representation simultaneously with a computation of the output data vector based on the additional training weights.

7. The method of claim 5, wherein the additional training weights are provided on one or more columns of an analog artificial intelligence tile comprising the neural network weight layer.

8. The method of claim 6, further comprising training the additional training weights, together with the artificial neural network, by minimizing a loss between the predicted representation and a calculated representation of the one or more scalar values.

9. A computer implemented method for applying one or more operations to an output data vector of an analog artificial intelligence tile, comprising:
receiving, at a neural network weight layer of the analog artificial intelligence tile, an incoming excitation vector;
computing an output data vector based on trained weights in the neural network weight layer;
storing, in one or more rows or columns of the artificial intelligence tile, additional trained weights for providing a predicted representation of one or more scalar values to be applied to the output data vector; and
using the predicted representation of the one or more scalar values during a forward inference of the artificial neural network by the incoming excitation vector to apply the one or more operations to the output data vector, while avoiding a computation used to compute an exact representation of the one or more scalar values from the output data vector.

10. The computer implemented method of claim 9, wherein the one or more operations include a mean and/or a standard deviation.

11. The computer implemented method of claim 9, wherein the one or more operations involve access to every element of the output data vector.

12. The computer implemented method of claim 9, further comprising providing training input from a set of training data to an artificial neural network, the training input providing the trained weights for the neural network weight layer.

13. The computer implemented method of claim 9, further comprising producing the predicted representation simultaneously with a computation of the output data vector based on the additional training weights.

14. The computer implemented method of claim 9, further comprising training the additional training weights, together with the artificial neural network, by minimizing a loss between the predicted representation and a calculated representation of the one or more scalar values.

15. A non-transitory computer readable storage medium tangibly embodying a computer readable program code having computer readable instructions that, when executed, causes a computer device to carry out a method for applying one or more operations to an output data vector of an artificial neural network, the method comprising:
receiving, at a neural network weight layer of the artificial neural network, an incoming excitation vector, the artificial neural network including one or more operations involving one or more scalar values to be computed across an output data vector of the artificial neural network; and
using a predicted representation of the one or more scalar values during a forward inference of the artificial neural network by the incoming excitation vector to apply the one or more operations to the output data vector while avoiding a computation used to compute an exact representation of the one or more scalar values from the output data vector.

16. The non-transitory computer readable storage medium of claim 15, wherein:
the one or more operations includes a mean and/or a standard deviation; and
the one or more operations involve access to every element of the output data vector.

17. The non-transitory computer readable storage medium of claim 15, the method further comprising providing training input from a set of training data to an artificial neural network, the training input providing the trained weights for the neural network weight layer.

18. The non-transitory computer readable storage medium of claim 15, the method further comprising:
providing additional training weights for predicting the one or more scalar values from the incoming excitation vector used to compute the output data vector; and
producing the predicted representation simultaneously with a computation of the output data vector based on the additional training weights.

19. The non-transitory computer readable storage medium of claim 18, the method further comprising providing the additional training weights on one or more columns of an analog artificial intelligence tile comprising the neural network weight layer.

20. The non-transitory computer readable storage medium of claim 18, the method further comprising training the additional training weights, together with the artificial neural network, by minimizing a loss between the predicted representation and a calculated representation of the one or more scalar values.
